(19) United States
(12) Patent Application Publication
(10) Pub. No.: US 2008/0176074 A1
(43) Pub. Date: Jul. 24, 2008

(54) ASYMMETRIC NANOPARTICLES FROM POLYMER NANOSPHERES

(76) Inventors: Ilsoon Lee, Okemos, MI (US); Devesh Srivastava, East Lansing, MI (US)

Correspondence Address: HARNESS, DICKEY & PIERCE, P.L.C., P.O. BOX 828, BLOOMFIELD HILLS, MI, 48303, US

(21) Appl. No.: 11/774,159

(22) Filed: Jul. 6, 2007

Related U.S. Application Data
(60) Provisional application No. 60/819,522, filed on Jul. 7, 2006.

(51) Int. Cl. B32B 5/16; B29C 39/02

(52) U.S. Cl. 428/402; 264/319

(57) ABSTRACT

Various kinds of nanostructured particles like nanorice and nanospears (i.e., tapered nanorods) are made using polymer nanospheres and ordered porous templates. For example, cylindrical nanopores of anodized alumina membranes are filled with polymer nanoparticles by a solvent assisted nanoinjection. Then the membranes are heated in an oven above the glass transition temperature of the polymer. The nanoparticles coalesce to form nanorods with a controlled aspect ratio and terminal contour. The terminal contour can be shaped in the form of nanorice, nanospears or tapered nanorods.

### CROSS-REFERENCE TO RELATED APPLICATIONS

This application claims the benefit of U.S. Provisional Application No. 60/819,522, filed on Jul. 7, 2006. The disclosure of the above application is incorporated herein by reference.

### U.S. GOVERNMENT SUPPORT

The subject matter described herein was developed in part with funds provided by the National Science Foundation under contract 0609164, and the Air Force Office of Scientific Research Equipment (AFOSR) under Grant No. FA9550-06-1-0417. The U.S. government has certain rights in the invention.

### INTRODUCTION

Nanosized functional particles are attractive for optical, electrical, magnetic, and biological applications. Recently, in addition to nanosize, the shape of nanoparticle is reported to be crucial, for example, in how it interacts with light by Halas and coworkers (Nano Letters 2005, 6, 27). They found that rice-shaped nanoparticles made of gold and iron oxide is the most sensitive surface plasmon resonance (SPR) nanosensor yet devised. They hope to get a far clearer picture of proteins and unmapped features on the surface cells by attaching them to scanning probe microscopes.

Although there are tremendous potential advantages of using anisotropic nanoparticles like nanorice instead of conventional spherical nanoparticles, the development of controlling such shape on the nanoscale is in its early stage. Some controlled growths of the end shape of nanorods with specific equipment at specific conditions have been reported for inorganic or metallic nanoparticles. Even though polymer nanorods and nanotubes have commonly been produced, since the fabrication was introduced by Wehrspohn and coworkers (Science 2002, 296, 1997), terminal contour control of polymer nanoparticles like nanorice or nanospears has remained as one of challenging tasks. If functional polymer nanoparticles can be shaped in the desired forms on the nanoscale, they can easily be functionalized to have far enhanced multifunctional properties using them as templates or substrates. In the fabrication of nanorods and nanotubes, template-assisted fabrication is gaining widespread interest because of its simplicity. Such novel nanostructures are expected to provide new functions in optoelectronic and biological applications that can not be attained with conventional spherical nanoparticles. Researches have used various kinds of membranes such as polycarbonates and anodized alumina membranes as templates for the fabrication of nanotubes and nanorods. However, no report of polymer nanorods has shown control of both aspect ratio and terminal contour. Additionally, no polymer nanospheres have been incorporated into the production of nanorods. Mostly, monomers, polymer melts or solutions are introduced into the nanopores for the production of nanorods and nanotubes. Other template assisted techniques use the step-edge and other methods involving template molecules in solution. Other nanorods production techniques which do not require templates include the electrospinning of nanofibers and also using biomolecules and self assembly processes.

The techniques that use membranes as templates include electrodeposition (Nano Letters 2004, 4, 1313), layer-by-layer deposition (e.g. Advanced Materials 2003, 15, 1849) and methods using commercially available metal plating solutions (e.g. J. Amer. Chem. Soc. 2002, 124, 11864). Zheng et al. have fabricated copolymer nanotubes and nanowires by having polymerizing copolymers inside the pores of alumina membranes (Chem. Comm. 2005, 1447). Anisotropic metallic nanoparticles like conical nanotubes rather than cylindrical nanotubes and nanorods have also been fabricated. Such anisotropic nanoparticles were fabricated using either a complex chemical vapor deposition set-up (Materials Science and Processing 2000, 71, 83) or a tapered pore that is coated with gold (Anal. Chem. 2004, 76 2425).

A simplified method to synthesize polymeric nanorods, nanorice and other shapes would be a significant advance.

### SUMMARY

To achieve faster production and also obtain subtle variation in the shape, size, and aspect ratio of nanoparticles, a fabrication method has been invented using nanoparticles and a nanoporous substrate such as an anodized alumina membrane template. In various embodiments, the system for fabricating nanorice and nanospears, and other nanoshapes is easy to set-up and perform on a laboratory bench top. Nanoscale fabrication can be performed without an elaborate set-up involving vacuum chambers or expensive equipment that are normally required for lithography based fabrication. The cost is low and the fabrication of different types of nanostructures is readily performed by changing key parameters, such as the particle size, template pore size, duration of ultrasonication and changing temperature or heating time.

In one aspect, the nanoparticles are made of a thermoplastic polymeric material and the method exploits the injection of a controlled amount and size of nanospheres into the nanopores of a substrate such as anodized alumina. The resulting nanostructures are controlled during the non-uniform heating of the polymer nanospheres by capillary forces, and wetting (or dewetting) onto the pore walls.

In various embodiments, commercially available alumina membranes (Whatman Anodized Alumina Membrane) are used as templates and polystyrene (PS) nanospheres (neutral, carboxylated, or sulfated polystyrenes from Polysciences, Inc.) for the fabrication of controlled aspect-ratio and terminal contour controlled nanoparticles (i.e., nanorice and nanospears). In a preferred embodiment, the pores of the membranes are filled with nanospheres by a solvent aided injection. Subsequent heat treatments allow the nanoparticles to coalesce and wet (or dewet) from the alumina nanopore walls to form nanoparticles with a controlled aspect-ratio and an interesting terminal curvature (i.e., round to sharp or pointed).

### BRIEF DESCRIPTION OF THE DRAWINGS

FIG. 1 shows a solvent-aided nanoinjection unit for injecting materials into the nanopore membranes.

FIG. 2 shows the overall process of making nanorods.

FIG. 3 shows electron micrographs of nanoshapes.

FIG. 4 illustrates formation of the nanoshapes.

FIG. 5 illustrates other shapes formed in the nanopores.

### DESCRIPTION

In one aspect of the invention, a method of making elongated nanoshapes involves delivering nanoparticles to nanopores of a substrate and thereafter heating the substrate that contains the nanoparticles in the nanopores to a temperature and for a time sufficient that the nanoparticles coalesce into nanoshapes, the nanoshapes being held in the nanopores. After the nanoshapes are formed in this way, the nanoshapes are harvested from the nanopores. In various embodiments, harvesting involves subjecting the substrate containing the nanoshapes in the nanopores to a solvent that dissolves the substrate without dissolving the nanoshapes. The nanopores are characterized by diameters in the nanometer region, for example, from 10-200 nm in diameter. In various embodiments, the nanopores are spherical or nearly so. A non-limiting example of a substrate is anodized alumina.

In various embodiments, the nanoparticles are made of a thermoplastic polymeric material and the heating of the substrate is carried out at a temperature above the glass transition temperature or T_{g} of the nanoparticles to cause them to coalesce into the nanoshapes. A non-limiting example of a thermoplastic polymeric material is polystyrene. As discussed further below, a variety of nanoshapes can be made by the current methods, including nanorods, nanospears, and nanorice.

In a particular aspect, the method of making elongated nanoshapes comprises pumping a fluid composition through a first set of nanopores in an anodized alumina substrate. The fluid composition is made of polymeric nanoparticles and a carrier liquid. In various embodiments, the fluid composition is a suspension or solution of the nanoparticles in the carrier liquid. After the fluid composition is pumped through a first set of nanopores, the carrier liquid is pumped through a second set of nanopores that are smaller than the first set. The second is also smaller than the size of the nanoparticles so that the nanoparticles are collected in the first set of nanopores by a filtering mechanism, while the carrier liquid is pumped further through the (second) pores. After a suitable amount of fluid composition has been pumped through the first set of nanopores, and the nanopores contain the polymeric nanoparticles, the anodized alumina substrate is heated at a temperature above the glass transition temperature of the nanoparticles for a time sufficient for the nanoparticles to coalesce into nanoshapes inside the nanopores. After this, the substrate containing the nanoshapes is exposed to a liquid medium that dissolves the substrate without dissolving the nanoshapes. As exemplified below, such a liquid includes an aqueous solution above pH 8, for example 3M sodium hydroxide solution.

In various aspects, the second set of nanopores is found in the same alumina substrate as the first set. Alternatively, or in addition, the second set of nanopores is provided by a polyelectrolyte multilayer membrane (PEM) coupled to the alumina membrane.

The nanopores are characterized by diameters in the nanometer region. In a non-limiting example, the nanopores are from about 10 to about 500 nm in diameter. If the nanopores are not exactly cylindrical, they are still nonetheless characterizable by effective diameters of 10 nm to 500 nm, wherein the effective diameter is the diameter of a sphere that would have the same cross-sectional area as the nanopore shape. The length of the nanopores in the alumina substrate varies according to the process in which it is manufactured. In a non-limiting example, the length of the pores is from about 10 μm to about 60 μm.

The second set of nanopores has a smaller diameter than the first set and in fact has a diameter smaller than the nanoparticles that are being pumped through the nanopores along with the carrier liquid. This has the effect of essentially stopping the flow of the nanoparticles through the pores so they are collected in the first set of nanopores, thereby partially or nearly completely filling them. Especially when the second set of nanopores is provided by a polyelectrolyte multilayer membrane, the second set of nanopores can have a diameter as low as 1 nm. In this embodiment, any nanoparticles greater than 1 nm in size will be prevented from passing through the second set.

In various embodiments, the fluid composition is a suspension of nanoparticles or a solution. Preferred nanoparticles are those made of metals (e.g. gold, silver, nickel, copper, and platinum) or of polymeric materials. In preferred embodiments, the nanoparticles are made of a thermoplastic polymer characterized by a glass transition temperature. When the nanoparticles are heated above the glass transition temperature, they coalesce into the shapes described below. Optionally, the nanoparticles can be heated above even the melting temperature to provide the nanoshapes described herein. Non-polymeric nanoparticles that have a melting point, such as the metallic materials such as gold or silver, are heated above the melting point.

The nanoparticles used in the methods are characterized by a diameter that is less than the diameter of the first set of nanopores and greater than the diameter of the second set of nanopores. It is to be understood that in all cases, the references to diameters also refers to the smallest axis of a particle or a pore that is not spherical or circular in shape. This is understood in the sense that a nanoparticle having a minor axis of a certain value will be able to enter in and pass through nanopores having a minor axis that is greater than that value, while nanoparticles having a larger minor axis than the nanopores will not be able to pass through. Thus, the nanoparticles have a diameter or minor axis that is lesser in value than the diameter or minor axis, as the case may be, of the first set of nanopores and have a diameter or minor axis greater than the diameter or minor axis, respectively, of the second set of nanopores. In various embodiments, the nanoparticles are characterized by a diameter or minor axis dimension of 10 nm or higher, and in various embodiments 200 nm or less, or 500 nm or less.

As noted the fluid composition contains a carrier liquid and nanoparticles. The composition of the nanoparticles in the fluid composition varies over a wide range and can be selected for experimental convenience. It will be appreciated that the more nanoparticles are in the fluid composition, the lower the volume of the fluid composition that needs to be pumped through the first set of nanopores in order to fill them sufficiently to make the nanoshapes described herein. In a non-limiting embodiment, the suspension or solution of nanoparticles in the carrier liquid contains about 8 mg nanoparticles per 200 mL of fluid composition.

In various embodiments, nano-sized objects (“nanoshapes”) in the form of nanorice, nanospears, and other elongated forms are provided. The nanorice, nanospears, and other objects are made of polymeric materials. Suitable polymeric materials include those that have a glass transition temperature below a temperature at which the membrane in which the particles are formed melts, decomposes, or deteriorates, as discussed further below. In one embodiment, the nanoparticles are made of polystyrene.

The prefix “nano” is used—for example in the terms nanoparticles, nanopores, nanospears, nanorice, nanorods, nanoshapes, and the like—to indicate that the dimensions of the particles are in the nanometer range. Thus, in various embodiments, nanoparticles are characterized by diameters or dimensions less than about 10 μm and especially less than about 1 μm (1000 nm). As described throughout, dimensions in the nanometer range for various of the pores, particles, and shapes range from about 1 nm up to about 1000 nm.

In various embodiments, the invention provides a method for making nanospears, nanorice, and similar objects by a solvent aided nanoinjection scheme. A suspension or solution of polymeric nanoparticles, such as nanospheres, is delivered into nanopores of a suitable substrate. The pores of the substrate are large enough to allow entry of the nanoparticles. The porous substrate is backed up by a second set of pores smaller than the nanoparticles but large enough to allow solvent molecules to pass. When the nanopores of the substrate are suitably filled, the substrate containing the polymeric nanospheres is optionally subjected to an ultrasonication treatment and then is heated to a temperature above the glass transition temperature of the polymeric material making up the nanospheres. Upon this heating step, the nanoparticles of polymeric material coalesce. The coalesced nanoparticles are then harvested from the membrane. In a preferred embodiment, harvesting is carried out by dissolving the membrane in a solvent system in which the polymeric material does not dissolve.

In a preferred embodiment, the porous substrate is made of a ceramic material; a non-limiting example is anodized alumina. Anodized alumina membranes are commercially available containing pores in a wide variety of sizes, such as from 20 nm to 200 nm or more. A ceramic material such as anodized alumina is able to withstand the temperature at which the polymeric materials are heated. An anodized alumina membrane is soluble, for example in a 3M NaOH solution, allowing harvesting of the nano-sized objects by dissolution in such a solution.

Anodized alumina films are commercially available in a variety of configurations. They are generally sold as relatively thin films, for example having a thickness of 1-100 μm, and more particularly about 10-60 μm. Because of the very small diameter or dimension of the nanopores in the anodized alumina membranes, they are sold and are useful as filtering materials for very small particles. In one embodiment, the anodized alumina membrane has a single set of nanopores throughout the entire membrane from one side to the other. The concentration and diameter of the nanopores in the membrane is determined by its method of manufacture. It is also possible to provide anodized alumina membranes that have two sets of nanopores in them. These are manufactured by exposing one surface of the membrane to a set of anodizing conditions and the other surface of the membrane to another set. As a result, the concentration and/or dimension of the nanopores are different on one surface than on the other. In this way, a first set of nanopores and a second set of nanopores can be provided in the same alumina membrane. In a typical commercially available embodiment, a first set of larger nanopores extends through about 80% of the thickness of the filter, while a second set of smaller nanopores extends from the opposite surface through about 20% of the thickness of the nanoporous membrane.

The resulting objects are provided in the form of nanorice, nanospears, and other nanoshapes. Preferably, the nano-sized objects are elongated in one direction and are provided in the form of elongated spheroids, oblate spheroids, spears (i.e., tapered rods), nanorods, nanorice, and the like. In various embodiments, the length (the dimension of the longer direction of the nanoparticles) is less than or equal to the length of the pores in the membrane substrate. In various embodiments, the lengths are less than or equal to about 5 μm (micrometer, 10⁻⁶ m), less than or equal to about 2 μm, and less than or equal to about 1 μm. In various embodiments, the nanoparticles are characterized by a length of 200 nm (0.2 μm) or more. The width or small dimension of the particles is preferably less than about 500 nm, less than or about 200 nm, less than or about 100 nm, or less than or about 50 nm. The width is generally greater than or equal to about 20 nm. The length and width of the nanoparticles is determined in various embodiments by the dimensions of the pores in the membrane substrate.

The methods described herein involve filling the nanopores with the liquid composition and depositing a sufficient amount of nanoparticles in the nanopores so that when they are subsequently heated, they coalesce into shapes that more or less fill the nanopores into which they had been deposited. In various aspects, the methods do not involve merely wetting the walls of the nanopores with a solution or with a melt of polymeric material. Rather, the methods involve filling the nanoparticles with fluid and/or nanoparticles and causing the particles to coalesce to form the nanoshapes. As a result, the nanoshapes formed by the current methods are solids such as the exemplified “nanorice”, “nanospears”, and “nanorods”. In various aspects, this is in contrast to prior art methods that because they involve wetting the walls only of the nanopores result in hollow structures such as nanotubes and the like. In various embodiments of the current methods, sufficient fluid composition containing carrier liquid and nanoparticles is pumped into the first set of nanopores in order to provide enough materials so that upon coalescence, solid elongated nanoshapes as described are formed.

In a preferred embodiment, the membrane substrate comprises a porous anodized alumina film. Typically such alumina films are formed on an aluminum surface by anodizing aluminum in an acid electrolyte. Characteristically, pores in the anodized alumina are aligned perpendicular to the film surface, with relatively good pore size uniformity. Procedures for making the alumina membranes are well known. Suitable anodized alumina membranes are commercially available, for example from Whatman in a variety of pore sizes and thicknesses.

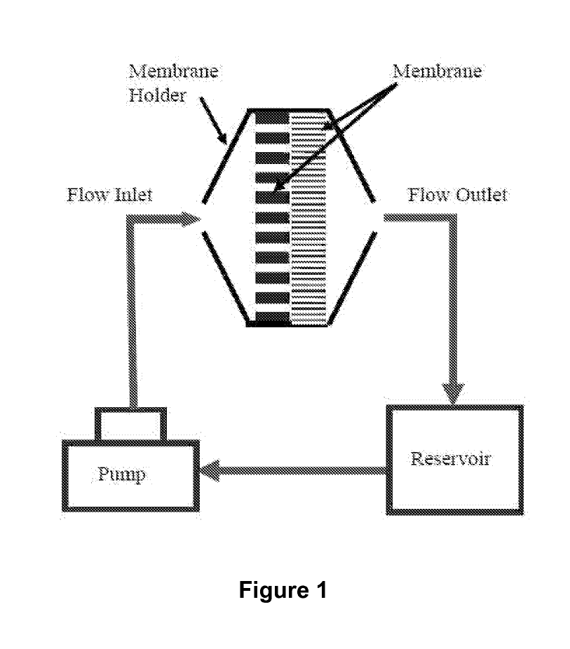

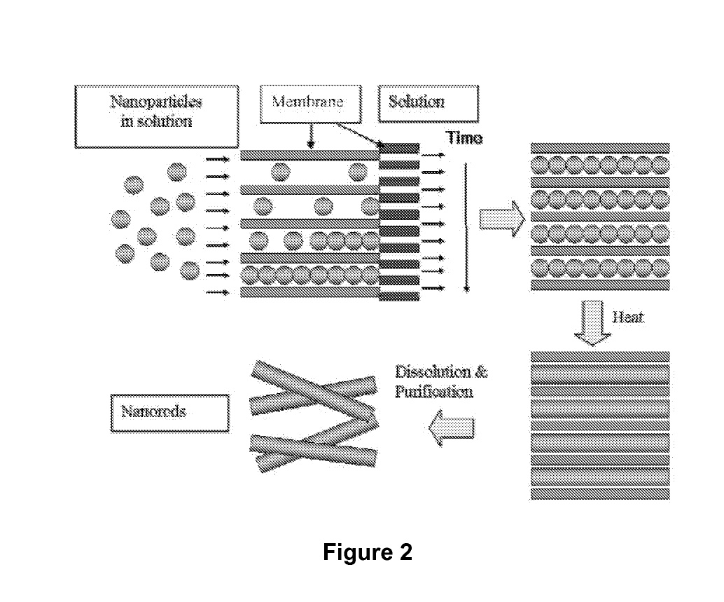

The second set of pores has pores smaller than the nanoparticles, and allow for the passage of solvent but not the particles. Non-limiting examples of the second porous member include anodized alumina membranes, which can be with a pore size down to at least 20 nm. In this embodiment alumina membranes with two pore sizes in series are illustrated in FIGS. 1 and 2. In another embodiment, polyelectrolyte multilayers (PEM's) having a tunable pore size down to about 1 nm are provided. The second pores act as a stop or filter for the particles of larger dimension. If desired, a PEM filter is used directly adjacent the substrate to act as a filter for nanoparticles, and a third porous member is provided adjacent the flexible PEM filter (so that the flexible PEM member is sandwiched between two more rigid members) to provide structural support (not shown) in the apparatus of the Figures.

Films formed by electrostatic interactions between oppositely charged poly-ion species are called “polyelectrolyte multilayers” (PEM). PEM are prepared layer-by-layer by sequentially immersing a substrate, such as a silicon, glass, or plastic slide, in positively and then negatively charged polyelectrolyte solutions in a cyclic procedure. Suitable substrates are rigid (e.g. silicon, glass) or flexible (e.g. plastics such as PET). A wide range of negatively charged and positively charged polymers is suitable for making the layered materials. Suitable polymers are water soluble and sufficiently charged (by virtue of the chemical structure and/or the pH state of the solutions) to form a stable electrostatic assembly of electrically charged polymers. Sulfonated polymers such as sulfonated polystyrene (SPS), anethole sulfonic acid (PAS) and poly(vinyl sulfonic) acid (PVS) are commonly used as the negatively charged polyelectrolyte. Quaternary nitrogen-containing polymers such as poly (diallyldimethylammonium chloride) (PDAC) are commonly used as the positively charged electrolyte.

Assembly of the PEM's is well known; an exemplary process is illustrated by Decher in Science vol. 277, page 1232 (1997) the disclosure of which is incorporated by reference. The method can be conveniently automated with robots and the like. A polycation is first applied to a substrate followed by a rinse step. Then the substrate is dipped into a negatively charged polyelectrolyte solution for deposition of the polyanion, followed again by a rinse step. Alternatively, a polyanion is applied first and the polycation is applied to the polyanion. The procedure is repeated as desired until a number of layers is built up. A bilayer consists of a layer of polycation and a layer of polyanion. Thus for example, 10 bilayers contain 20 layers, while 10.5 bilayers contain 21 layers. With an integer number of bilayers, the top surface of the PEM has the same charge as the substrate. With a half bi-layer (e.g. 10.5 illustrated) the top surface of the PEM is oppositely charged to the substrate. Thus, PEM's can be built having either a negative or a positive charge “on top”.

The PEM membranes are characterized by nanopores that are as low as 1 nm in dimension. The small size of the nanopores and the tortuous path through the membrane allows the carrier liquid to pass, but holds up the nanoparticles through a filtering action.

In various aspects, the invention provides a versatile and effective approach for shaping nanoscale structures using ordered nanopored membranes and a simple solvent-aided nano-injection molding process of polymer nanospheres. By exploiting non-uniform heating and resulting wetting or capillary forces of nanospheres filled inside the cylindrical nanopores of membranes, novel nanostructured, anisotropic nanoparticles such as nanorice and nanospears are obtained. In various embodiments, the method is easy to implement without complicated chemistry or expensive equipment. Therefore, after obtaining spherical nanoparticles of any materials, the method can easily change the symmetrical nanoparticle into other geometries with less symmetry.

In a particular aspect, the invention provides nanoparticles made of polymeric material and characterized by an aspect ratio, which is the ratio of the length of the long axis of the anisotropic particle to its diameter, where the diameter is taken in a direction perpendicular to the long axis. Importantly, the nanoparticles are provided in pure or isolated form, and not as dispersed particles in other media or as dispersed nanodomains in a polymeric composite. In preferred embodiments, the nanoparticles, called “nanorice” because the shape is evocative of a grain of rice, have sizes that tend to give them useful optical properties. For example, preferably, the diameter of the nanorice nanoparticles is 1000 nm or less, and is about 5 nm or greater, preferably 10 nm or greater. In various embodiments, the diameters range from 10 nm to 1000 nm, from 10 nm to about 500 nm, or from about 10 nm to about 200 nm. The aspect ratio, defined as the ratio of the long axis dimension to the diameter, is preferably greater than 1 and less than about 100, less than about 50, or less than about 10. In other preferred embodiments, the aspect ratio is less than or about 5 or less than or about 2.

Nanorice nanoparticles are formed according to the invention by delivering starting nanoparticles (which for convenience can be in the form of commercially available nanospheres) into cylindrical nanopores of a nanoporous substrate (having a diameter in the nano region of from about 10 nm to about 1000 nm) in such a way that the nanopores are less than completely filled with the nanoparticles. This is illustrated in the Example below. The nanoparticles are then heated in the nanopores at a temperature at which the particles can coalesce, but below a temperature at which the polymeric material liquefies. For an amorphous polymer, the heating is above the glass transition temperature (T_{g}), and preferably no more than 20° C. above T_{g} or no more than 10° C. above T_{g}. For a crystalline polymer, heating is above T_{g} but preferably below the crystalline melting point (Tₘ), wherein the melting point is determined by differential scanning calorimetry. Harvesting of the resulting nanorice nanoparticles is accomplished by dissolving away the substrate without dissolving the particles. As an example, 3M NaOH is used to dissolve an anodized alumina substrate. Conditions for formation of the nanorice nanoparticles can be found by varying the amount of nanoparticles delivered to the nanopores, the temperature and duration of heating the polymeric material in the nanopores, and the nature of any ultrasonication step carried, as described elsewhere herein.

The nanorice nanoparticles are elongated shapes that are ellipsoidal in dimension, and tapered on both ends so that the shape resembles that of a grain of rice, as seen for example in the Figures. In various aspects, the shape can be said to resemble orzo, or even an American football. In any case, the nanorice particles are preferably of such dimensions that the tapered ends contribute to the physical or optical properties. That is to say, preferably the nanorice particles are not so long compared to their diameter that the particles resemble more a wire than a tapered particle. In these preferred embodiments, the aspect ratio of the particles is in the ranges given above.

Further non-limiting descriptions of the invention is given in the disclosure and examples that follow.

FIG. 2 illustrates an embodiment of the overall process. A specific amount of nanoparticles in suspension or in solution (e.g. polystyrene nanospheres) is pumped through membranes with desired pore sizes in series (first large and then small pores) or a membrane having both large and small pores at each side. The size of nanospheres is in between the large and the small pores so that the nanospheres are trapped only in the large pores. Once the large pore membrane is filled with the desired amount of nanospheres it is taken out, heated above the glass transition temperature of the polymer (e.g., at about 120° C. for polystyrene) for a time sufficient to cause the particles to coalesce, melt, or fuse, and then placed in a 3 M NaOH aqueous solution where the alumina membranes dissolve. Then the remaining polymer nanoparticles are filtered using a centrifuge and washed several times in deionized (DI) water to remove any residual NaOH. To image the resulting structure of nanoparticles, a drop of the sample suspension is put on a glass slide and then dried. The dried samples on a glass slide are sputtered with gold (around 5 nm thick) for scanning electron microscopy (SEM) analysis. SEM used for high resolution imaging was TEOL 6300F with field emission.

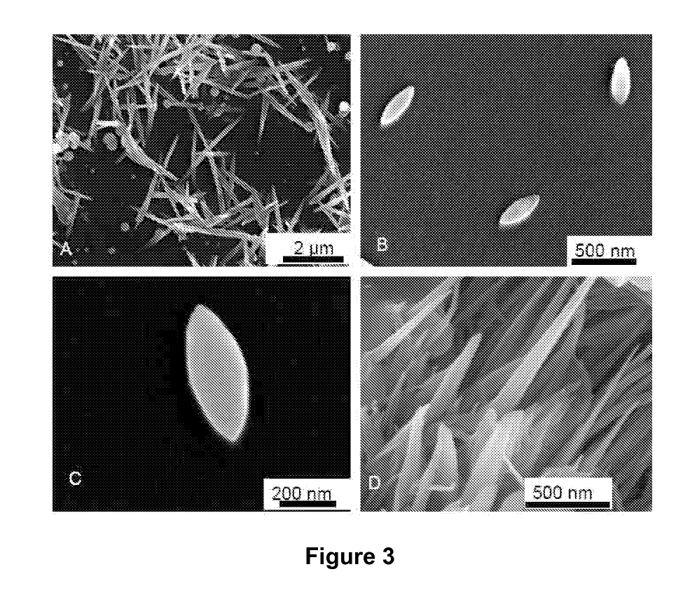

FIG. 3A shows the resulting nanorods tapered at the ends were made of (8.1 mg of 140 nm PS nanoparticles in 200 ml of water) PS nanospheres in 200 nm pore-size alumina membrane stacked against 20 nm pore-size membrane. A unique and peculiar terminal contour was observed of these polymer nanorods (i.e., nanospears). FIG. 3B shows tapered nanorods of smaller aspect-ratio (i.e., nanorice) that were fabricated by reducing the amount of nanospheres injected through the membrane. FIG. 3C shows a higher magnification image of the nanorice. In addition, we used smaller nanospheres and a smaller membrane. This membrane has two pore sizes at each end, 20 nm and 200 nm. Both pores are cylindrical and they meet at around 2 μm from the 20 nm end. The concentration for 50 nm PS nanospheres was 2.3 mg in 200 ml of DI water. 100 ml of this suspension was injected from the large pore side to the small side and then was heated at 120° C. for 2 hours. Since these nanospheres (50 nm) were much smaller than the large pore (200 nm) in size they must have been closely packed and this case we observed much longer and sharper tapered nanowires, as shown in FIG. 3D. The composition of the particles was confirmed to be mainly carbon without Al by energy dispersive spectroscopy (EDX) analysis.

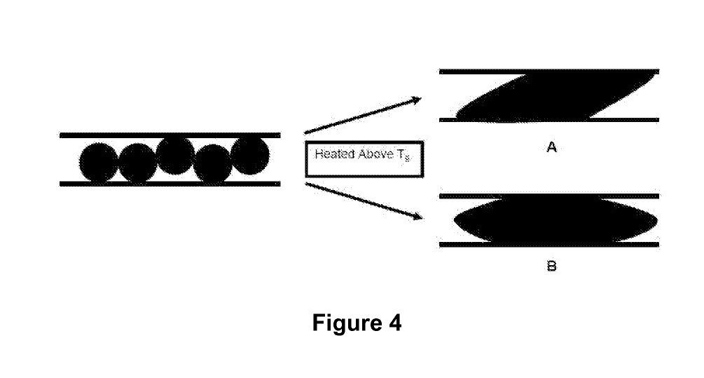

A possible explanation for the formation of the tapered tip is illustrated in FIG. 4. When the cylindrical pore diameter of the membrane is, say, 200 nm and the PS nanospheres are smaller in diameter (e.g. 140 nm in diameter), nanospheres align themselves in the cylindrical pores. The pore diameter is larger than the nanosphere diameter. Hence the nanospheres (140 nm in this case) have only a small contact area with the pore wall as shown in the left side of FIG. 4. This illustrates an exaggerated effect of non-uniform heating and resulting on the coalescence of nanospheres, and the shape change caused by wetting (or dewetting) and capillary force.

As the nanospheres-filled membrane is heated above the glass transition temperature of the polymer used, there are two main heating mechanisms: conduction (through the alumina wall) and convection (through the air). Radiation is less important because of the relatively low temperature. In the first case the pore wall is a better heating source than air. There would be more heat transfer through the small contact area between the wall and nanospheres than through air. Hence the nanospheres would start to partially deform and wet at the pore wall. As polymers are being softened in the cylindrical nanodomain, capillary forces come to play an important role in moving and shaping the softened polymer.

Capillary force can allow these softened polymers to flow slowly onto the nanopore walls, thus adjacent nanospheres coalesce to form a continuous shape. The nanosphere at the end just stretches further along the cylindrical nanopores. Since the temperature is only slightly above the glass transition polystyrene, there is only partial wetting of the pores by the softened polystyrene as discussed by Zhang et al. (Nano Letters 2006, 6, 1075). This implies that the softened polystyrene will form a meniscus at the ends, as is observed by Zheng et al. in the formation of polystyrene nanorods. But in our case as polystyrene nanoparticles are used hence this partial wetting and limited supply of polymer leads to the formation of tapered nanospears and nanorice. Alternatively, at the end nanosphere did not have another nanosphere to coalesce with; therefore, it forms a tapered end due to partial wetting as illustrated in FIG. 4A. On the other hand, when heat convection is dominant, the softened polymer parts will be to the outside of nanoparticles, rather than the nanospheres wall contact region. The softened polymers connect neighboring nanoparticles together to form nanorods. At both ends, the softened polymers from the outsides of nanoparticles can be further extended to the empty sides by capillary forces, resulting in forming nanorounded (i.e., nanorice) or nanosharpened edges (i.e., nanospears), as illustrated in FIG. 4B.

The terminal contour development of nanorice or nanospear is somewhat similar to that of icicles in which water added to the outside icicles toward the narrow tip by the force of gravity. In this system, the external force analogous to the gravitational force will be the capillary forces which lead to the tapering of the ends. This leads to the formation of tapered nanorods. Hence, in the formation of nanorods with sharp terminal contour, capillary forces along with wetting (FIG. 4A) or dewetting (FIG. 4B) may play an important role, which can be related to the non-uniform heating by either conduction or convection at the nanometer scale. It is believed the softened polymer nanospheres non-uniformly heated to a temperature above the glass transition temperature tend to stretch slowly to form tapered nanorods.

In various embodiments, during the solvent-aided nanoinjection process, the nanospheres tend to stay separated from each other rather than sitting adjacently. If desired or necessary, intermediate ultrasonication of the membrane is used to tightly pack the nanospheres into the membrane pores. This intermediate step of ultrasonication after pumping the certain amount nanosphere suspension also helps remove excess particles, which tend to stay on the membrane surface. These particles could prevent further nanospheres from being delivered to the membrane pores and reduce the aspect ratio nanorods.

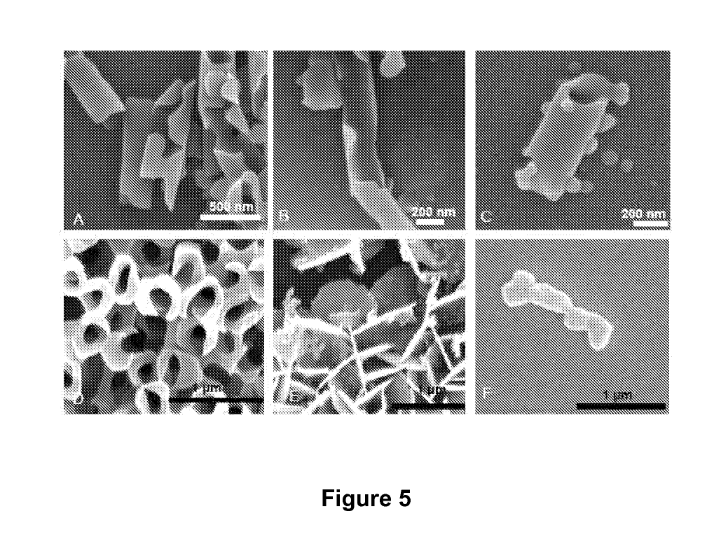

In preferred embodiments, the nanoinjection process described herein results in the formation of solid nanoshapes such as those generically characterized as “nanorods”, “nanospears” and “nanorice”. As shown in FIG. 5, various other nanostructures are formed such as incomplete nanotubes (i.e., perforated nanotubes) (A, B, and C), broken nanodoughnuts (D), and nanodiscs (E). These nanostructures show evidence for the thermal wetting of PS onto the cylindrical alumina nanopore walls as heat transfers to PS nanospheres through the wall. It is expected that further variation of the PS nanospheres packing, heating temperature, and time would allow the fabrication of novel nanostructures. FIG. 5F illustrates the intermediate step in the coalescence of the particles. Due to a short heating time, the spherical particles have not completely lost their structure. The nanospheres towards the middle can be seen merging together whereas the nanospheres at the end are tending to form a slightly tapered shape.

Important parameters governing the final shape of the nanostructures are the nanopore and nanosphere sizes along with heating temperature and time, and the amount of nanospheres delivered into the nanopores in relation to the pore volume, as discussed above. Experiments can be conducted to observe the effects of these parameters and how the fine tuning of other key parameters can lead to other interesting shapes.

### EXPERIMENTAL

A system is assembled as shown in FIG. 1. For nanospears 8.1 mg of 140 nm diameter polystyrene nanoparticles (Polysciences Inc.) is suspended in 200 ml of de-ionized (DI) water. This solution is pumped through 200 nm alumina membrane (Whatman) stacked against 20 nm pore sized membrane. After every 25 mL of pumped solution, ultrasonication of the membrane containing the suspension is carried out (1510 Branson lab sonicator, 70 W for 5 minutes at 42 kHz) to remove nanoparticles from the surface. The membranes are removed and 200 nm membrane is heated at 120° C. for 2 hours. The membrane is dissolved in 3M NaOH and subsequently washed in DI water and dried on glass slips for imaging using Scanning Electron Microscope. For nanorice, only 25 ml of same solution is pumped and rest of the procedure is exactly the same, including a final ultrasonication step to remove nanoparticles from the surface.

What is claimed is:

1. A method for making elongated nanoshapes, comprising
delivering nanoparticles to the nanopores of a substrate;
heating the substrate at a temperature and for a time sufficient to coalesce the nanoparticles into nanoshapes in the nanopores; and
harvesting the nanoshapes from the nanopores.

2. A method according to claim 1, wherein the nanopores have a diameter of about 10 nm to about 200 nm.

3. A method according to claim 1, wherein the substrate is anodized alumina.

4. A method according to claim 1, wherein the nanoparticles comprise a thermoplastic polymer and heating is carried out above the glass transition temperature of the nanoparticles.

5. A method according to claim 1, wherein the nanoparticles comprise polystyrene.

6. A method according to claim 1, wherein harvesting comprises dissolving the substrate without dissolving the nanoshapes.

7. A method according to claim 1, wherein the nanoshapes are selected from the group consisting of nanorods, nanospears, and nanorice.

8. A method of making elongated nanoshapes, comprising
pumping a fluid composition comprising polymeric nanoparticles and a carrier liquid through a first set of nanopores in an anodized alumina substrate;
pumping the carrier liquid through a second set of nanopores smaller than first set, and smaller than the size of the nanoparticles;
heating the anodized alumina substrate at a temperature above the glass transition temperature of the nanoparticles for a time sufficient for the nanoparticles to coalesce into nanoshapes inside the nanopores; and
exposing the substrate containing the substrate to a liquid that dissolves the substrate without dissolving the nanoshapes.

9. A method according to claim 8, wherein the second set of nanopores is in the anodized alumina substrate.

10. A method according to claim 8, wherein the second set of nanopores is provided in a polyelectrolyte multilayer.

11. A method according to claim 8, wherein the first set of nanopores is characterized by a diameter of about 10 nm to about 500 nm and a length of about 10 μm to about 60 μm.

12. A method according to claim 11, wherein the second set of nanopores is characterized by a diameter of about 1 nm to about 50 nm.

13. A method according to claim 8, wherein the fluid composition comprises a suspension of polymeric nanoparticles.

14. A method according to claim 8, wherein the fluid composition comprises a solution of polymeric nanoparticles.

15. A method according to claim 8, wherein the nanoparticles comprise a thermoplastic polymer.

16. A method according to claim 8, wherein the nanoparticles are characterized by a diameter of about 10 nm to about 200 nm.

17. A method according to claim 8, comprising dissolving the substrate in water at a pH above 8.0.

18. A polymeric nanorice nanoparticle having a diameter of from 10 to 1000 nm, and an aspect ratio greater than 1 and less than about 100.

19. The nanoparticle of claim 18, wherein the aspect ratio is less than about 50.

20. The nanoparticle of claim 18, wherein the aspect ratio is less than about 10.

21. The nanoparticle of claim 18, wherein the aspect ratio is less than about 5.

22. The nanoparticle of claim 20, wherein the diameter is 500 nm or less.

23. The nanoparticle of claim 20, wherein the diameter is 200 nm or less.

24. The nanoparticle of claim 20, wherein the diameter is 100 nm or less.

25. A method of making a nanorice nanoparticle characterized by an aspect ratio of greater than 1 and less than or equal to about 100, the method comprising:
a) delivering polymeric nanoparticles to the cylindrical nanopores of a nanoporous substrate, wherein the total amount of nanoparticles delivered is less than the amount required to fill the nanopores, and where the nanoparticles comprise a thermoplastic polymeric material characterized by a glass transition temperature;
b) heating the nanoparticles in the nanopores at a temperature above the glass transition temperature but below a temperature at which the polymeric material liquefies, for a time sufficient to form tapered nanoshapes having an aspect ratio greater than 1 and less than 100; and
c) harvesting the nanorice nanoparticle by dissolving the nanoporous substrate in a liquid that does not dissolve the nanorice nanoparticle.

26. The method according to claim 25, wherein the polymeric nanoparticles of step a) are spherical.

27. The method according to claim 25, wherein the substrate is an anodized alumina membrane.

28. The method according to claim 25, comprising heating the nanoparticles in the nanopores at a temperature not more than 20° C. above the glass transition temperature.

29. The method according to claim 25, comprising heating the nanoparticles in the nanopores at a temperature not more than 10° C. above the glass transition temperature.
